(19) United States
(12) Patent Application Publication
(10) Pub. No.: US 2023/0057584 A1
(43) Pub. Date: Feb. 23, 2023

(54) ROBOT CLEANER AND METHOD FOR CONTROLLING THE SAME

(71) Applicant: LG ELECTRONICS INC., Seoul (KR)

(72) Inventor: Jaemin KIM, Seoul (KR)

(21) Appl. No.: 17/793,198

(22) PCT Filed: May 8, 2020
(86) PCT No.: PCT/KR2020/006099

§ 371 Date: Jul. 15, 2022

(30) Foreign Application Priority Data
Jan. 21, 2020 (KR) 10-2020-0008074

(51) Int. Cl. A47L 9/28; G06T 7/12; G06T 7/73; G05D 1/02

(52) U.S. Cl. CPC A47L 9/2826; A47L 9/2852; G06T 7/12; G06T 7/74; G05D 1/0274; G05D 1/0214; G05D 1/0246; A47L 2201/04; G06T 2207/20021; G05D 2201/0203

(57) ABSTRACT

Provided are a robot cleaner and a method for controlling the same, which are capable of determining the presence or absence of a liquid based on an image captured by a camera. The robot cleaner includes a cleaner body including a traveling part, a camera provided on one surface of the cleaner body and configured to acquire an image of surroundings of the cleaner body, and a controller provided in the cleaner body and configured to control the traveling part. The controller is configured to divide an image acquired by the camera into a plurality of images with respect to a reference line, and determine the presence or absence of a liquid based on two or more images among the plurality of divided images.

### TECHNICAL FIELD

The present disclosure relates to a robot cleaner and a method for controlling the same.

### BACKGROUND ART

In general, robots have been developed for industrial use and have been responsible for a part of factory automation. In recent years, the field of application of robots has been expanded, and home robots that can be used in general homes are also being made.

A typical example of home robot is a robot cleaner, which is a type of household appliance that suctions and cleans surrounding dust or foreign substances while driving a certain area by itself. The robot cleaner is generally provided with a rechargeable battery and an obstacle sensor that allows the robot cleaner to avoid obstacles during traveling. Therefore, the robot cleaner can travel and clean by itself.

In order for the robot cleaner to travel by itself, it is essential to recognize the location of the robot cleaner. Typically, the current location of the robot cleaner may be recognized by using a variety of sensor data and a map of an environment in which the robot cleaner operates.

However, when a liquid is present in a cleaning area, the robot cleaner may not recognize the liquid. When the robot cleaner does not recognize the liquid, there is a problem in that the robot cleaner travels with the liquid on the wheels and contaminates the cleaning area. In addition, there is a problem in that the liquid is suctioned through a suction part of the robot cleaner, thus causing the malfunction of the robot cleaner.

In order to solve these problems, the following prior art has been proposed: Korean Patent Application Publication No. 10-2011-0119196 A (published on Nov. 2, 2011)

The prior art discloses a moving body for determining the presence or absence of a liquid when the two conductive wires are provided to the outside and the two conductive wires are electrically connected by the liquid. However, since a sensor is located in the center of the moving body, the moving body is contaminated before determining the presence or absence of the liquid. In addition, since the two conductive wires of the moving body are exposed, the two conductive wires are vulnerable to corrosion.

### DISCLOSURE OF INVENTION

### Technical Problem

An aspect of the present disclosure is directed to providing a robot cleaner and a method for controlling the same, which are capable of determining the presence or absence of a liquid based on an image captured by a camera.

Another aspect of the present disclosure is directed to providing a robot cleaner and a method for controlling the same, which are capable of performing an avoiding operation by calculating a distance to the liquid when the liquid is present.

### Solution to Problem

In order to solve the above problems, a robot cleaner according to an embodiment of the present disclosure may recognize a liquid by using the reflection characteristics of the liquid to analyze an image acquired by a camera provided in the robot cleaner. In addition, the robot cleaner according to the embodiment of the present disclosure may perform an operation of avoiding the liquid, thereby preventing malfunction and improving product reliability.

In addition, since the image acquired by the camera provided in the robot cleaner is analyzed, the liquid may be detected without adding a separate sensor or the like, thereby reducing costs.

In one embodiment, a robot cleaner includes a cleaner body including a traveling part, a camera provided on one surface of the cleaner body and configured to acquire an image of surroundings of the cleaner body, and a controller provided in the cleaner body and configured to control the traveling part.

The controller may be configured to divide an image acquired by the camera into a plurality of images with respect to a reference line, and determine the presence or absence of a liquid based on two or more images among the plurality of divided images.

The reference line may be a boundary line between a wall surface and a floor surface in the image acquired by the camera.

The plurality of images may include a first image and a second image, and the two or more images may be the first image and the second image.

The controller may be configured to acquire a third image in which the second image is symmetrical with respect to the reference line, and determine the presence or absence of the liquid by using the first image and the third image.

The controller may be configured to extract a plurality of first feature points extracted from the first image and a plurality of second feature points extracted from the third image, and determine the presence or absence of the liquid based on matching information about the plurality of second feature points corresponding to the plurality of first feature points.

The controller may be configured to extract a plurality of first feature points extracted from the first image and a plurality of second feature points extracted from the second image, and determine the presence or absence of the liquid based on matching information about the plurality of second feature points corresponding to the plurality of first feature points.

The controller may be configured to make the plurality of second feature points symmetrical with respect to the reference line, and determine the presence or absence of the liquid by using matching information about the plurality of second symmetrical feature points and the plurality of first feature points.

When the controller determines that the liquid is present, the controller may be configured to acquire a reference feature point located at a shortest distance from the cleaner body in the third image, and calculate the shortest distance based on the reference feature point.

The reference feature point may be one of the plurality of second feature points.

The controller may be configured to acquire the reference feature point separately from the plurality of second feature points.

The controller may be configured to detect an angle from the camera to the reference feature point located at the shortest distance from the cleaner body, and calculate the shortest distance based on a height from the floor surface to the camera.

The controller may be configured to: generate a map based on the information acquired from the camera; and display, on the map, an area where the liquid is present, based on the shortest distance.

The controller may be configured to cause the cleaner body to travel while avoiding the area where the liquid is present.

In one embodiment, a method for controlling a robot cleaner includes acquiring an image by capturing an image of surroundings through a camera while traveling, dividing the acquired image into a plurality of images based on a reference line, determining the presence or absence of a liquid based on two or more images among the plurality of images, and when it is determined that the liquid is present, displaying, on a map, an area where the liquid is present, and driving the robot cleaner to avoid the area where the liquid is present.

The reference line may be a boundary line between a wall surface and a floor surface in the image acquired by the camera.

The plurality of images may include a first image and a second image, and the two or more images may be the first image and the second image.

The determining of the presence or absence of the liquid may include extracting a plurality of first feature points extracted from the first image and a plurality of second feature points extracted from the second image, and determining the presence or absence of the liquid based on matching information about the plurality of second feature points corresponding to the plurality of first feature points.

In one embodiment, a method for controlling a robot cleaner includes acquiring an image by capturing an image of surroundings through a camera while traveling, dividing the acquired image into a first image and a second image based on a reference line, acquiring a third image in which the second image is symmetrical with respect to the reference line, determining the presence or absence of a liquid based on the first image and the third image, and when it is determined that the liquid is present, displaying, on a map, an area where the liquid is present, and driving the robot cleaner to avoid the area where the liquid is present.

The determining of the presence or absence of the liquid may include extracting a plurality of first feature points extracted from the first image and a plurality of second feature points extracted from the third image, and determining the presence or absence of the liquid based on matching information about the plurality of second feature points corresponding to the plurality of first feature points.

### Advantageous Effects of Invention

The present disclosure provides a robot cleaner and a method for controlling the same, which are capable of determining the presence or absence of a liquid based on an image captured by a camera.

The present disclosure also provides a robot cleaner and a method for controlling the same, which are capable of performing an avoiding operation by calculating a distance to the liquid when the liquid is present.

### BRIEF DESCRIPTION OF DRAWINGS

The accompanying drawings, which are included to provide a further understanding of the invention and are incorporated in and constitute a part of this application, illustrate embodiments of the invention and together with the description serve to explain the principle of the invention. In the drawings:

FIG. 1 is a block diagram showing main components of a robot cleaner according to an embodiment of the present disclosure.

FIG. 2 is a view showing a state in which the robot cleaner according to the present embodiment detects a liquid.

FIG. 3 is a block diagram showing a configuration of a controller according to an embodiment of the present disclosure.

FIG. 4 is a view showing a state in which an image is divided with respect to a reference line, according to an embodiment of the present disclosure.

FIG. 5 is a view showing a state in which the presence or absence of a liquid is determined by using a divided image, according to an embodiment of the present disclosure.

FIG. 6 is a view showing a state in which the robot cleaner calculates a distance to the liquid, according to the present embodiment.

FIG. 7 is a flowchart of a method for controlling a robot cleaner, according to an embodiment of the present disclosure.

### MODE FOR THE INVENTION

Hereinafter, embodiments of the present disclosure will be described in detail with reference to the drawings. It should be noted that, in adding reference numerals to the components of each drawing, the same components are denoted by the same reference numerals even though they are shown in different drawings. In describing the present disclosure, when the detailed description of the relevant functions or configurations is determined to unnecessarily obscure the gist of the disclosure, the detailed description may be omitted.

In describing the components of the embodiments of the present disclosure, the terms such as first, second, A, B, (a), and (b) may be used. These terms are only used for distinguishing a component from another, and the nature, order, or sequence of the components is not limited by these terms.

In addition, the spirit of the present disclosure may not be said to be limited to the presented embodiments, and other embodiments falling within the scope of the present disclosure may be easily proposed by adding, changing, or deleting another component.

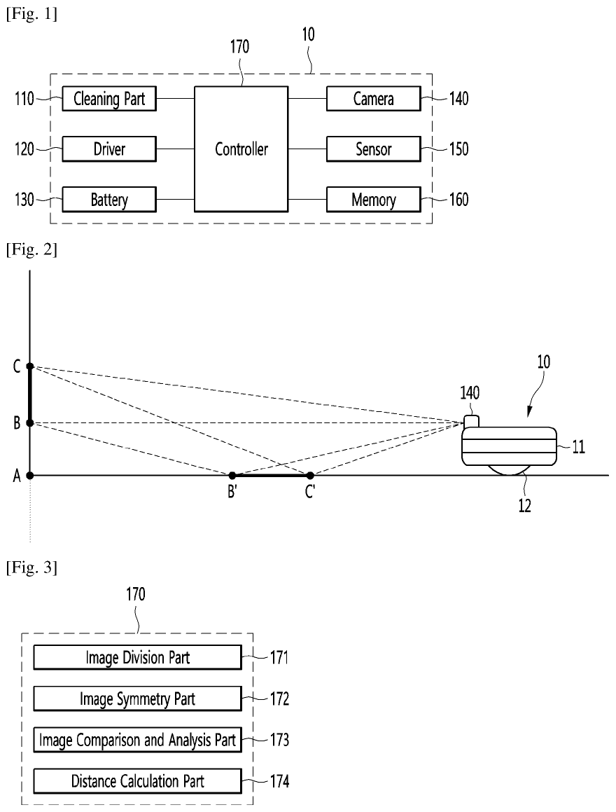

FIG. 1 is a block diagram showing main components of a robot cleaner according to an embodiment of the present disclosure, and FIG. 2 is a view showing a state in which the robot cleaner according to the present embodiment detects a liquid.

Referring to FIGS. 1 and 2, a robot cleaner 10 according to an embodiment of the present disclosure may suction foreign substances while moving along a floor of a cleaning area.

The robot cleaner 10 may include a cleaner body 11 that forms the appearance of the robot cleaner 10. The cleaner body 11 may define a space in which components are accommodated.

The cleaner body 11 may be provided with a cleaning part 110 such that the robot cleaner 10 moves and cleans foreign substances. The cleaning part 110 may include a suction motor that generates suction power, a suction port through which air flow generated by the suction motor is suctioned, a dust separator that separates foreign substances in the air flow suctioned through the suction port, and a dust bin in which the foreign substances separated by the dust separator are accumulated.

The robot cleaner may include a traveling part 12 rotatably provided in the cleaner body 11. The traveling part 12 may include a left wheel and a right wheel. As the traveling part 12 rotates, the cleaner body 11 may move along the floor of the cleaning area. In this process, foreign substances are suctioned through the cleaning part 110.

The robot cleaner 10 may further include a driver 120 that drives the traveling part 12.

The driver 120 may drive the traveling part 12. For example, the driver 120 may include a first driving motor that rotates the left wheel and a second driving motor that rotates the right wheel.

Therefore, the robot cleaner 10 may move straight, move backward, or turn through the independent control of the first driving motor and the second driving motor.

For example, when the first driving motor and the second driving motor are rotated in the same direction, the robot cleaner 10 may move straight, and when the first driving motor and the second driving motor are rotated at different speeds or in opposite directions, the traveling direction of the robot cleaner 10 may be switched.

In addition, the robot cleaner 10 may include a rechargeable battery 130. The components constituting the robot cleaner 10 may be supplied with power from the battery 130. Therefore, while the battery 130 is charged, the robot cleaner 10 is capable of traveling by itself in a state of being electrically separated from commercial power.

The robot cleaner 10 may further include a camera 140 that acquires an image by capturing surroundings of the robot cleaner 10.

The camera 140 may be disposed to look upward or forward of the cleaner body 11, but the present disclosure is not limited thereto. In addition, the camera 140 may be fixedly installed on the cleaner body 11 or may be installed such that the direction in which the camera 140 faces is changed.

The camera 140 may include a lens having a wide angle of view such that the entire area in which the robot cleaner 10 is located can be captured.

In addition, the camera 140 captures at least the front area based on the moving direction of the robot cleaner 10, and the captured image may be transmitted to the controller 170 to be described below.

The robot cleaner 10 may further include a sensor 150.

The sensor 150 may be at least one of a laser sensor, an ultrasonic sensor, an infrared sensor, or a position sensitive device (PSD) sensor, but the present disclosure is not limited thereto.

The robot cleaner 10 may detect an obstacle in the forward direction, that is, in the traveling direction, by using the sensor 150. When a transmitted signal is reflected and incident, the sensor 150 may input information about the presence or absence of the obstacle or information about a distance to the obstacle to the controller 170 as an obstacle detection signal.

The robot cleaner 10 may further include the controller 170 that controls an overall operation of the robot cleaner 10.

The controller 170 may control the driver 120 to move the robot cleaner 10. The driver 120 may independently control the operations of the first driving motor and the second driving motor of the traveling part 12 through the controller 170 such that the robot cleaner 10 travels while moving straight or rotating.

In addition, the controller 170 may recognize the current location of the robot cleaner 10 and generate a map based on information detected by the camera 140 and the sensor 150.

The robot cleaner 10 may further include a memory 160 that stores map information generated by the controller 170.

In addition, the memory 160 may store a variety of control information for controlling the robot cleaner 10. For example, the memory 160 may store reference data for the controller 170 to determine the obstacle and may store obstacle information such as a distance and a size of the detected obstacle.

Examples of the memory may include hard disk drive (HDD), solid state disk (SSD), silicon disk drive (SDD), ROM, RAM, CD-ROM, magnetic tape, floppy disk, and optical data storage devices, but the present disclosure is not limited thereto.

Hereinafter, the configuration of the controller 170 for detecting the liquid will be described in more detail.

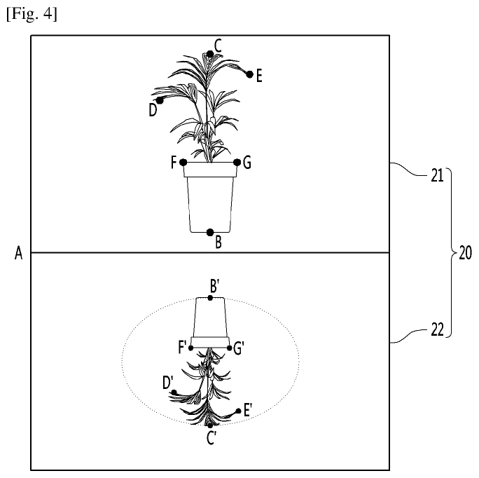

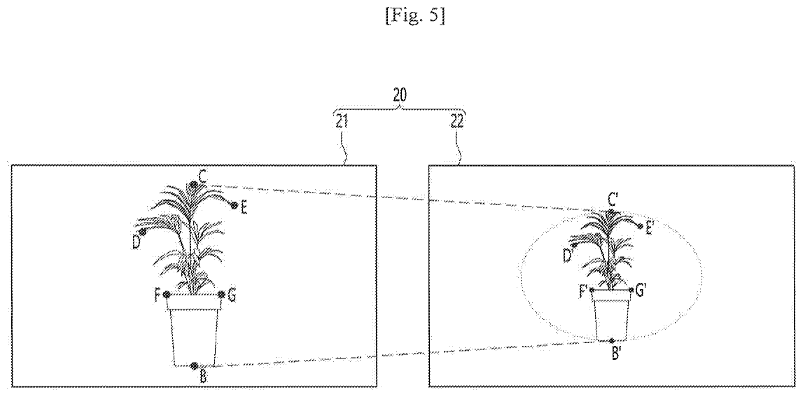

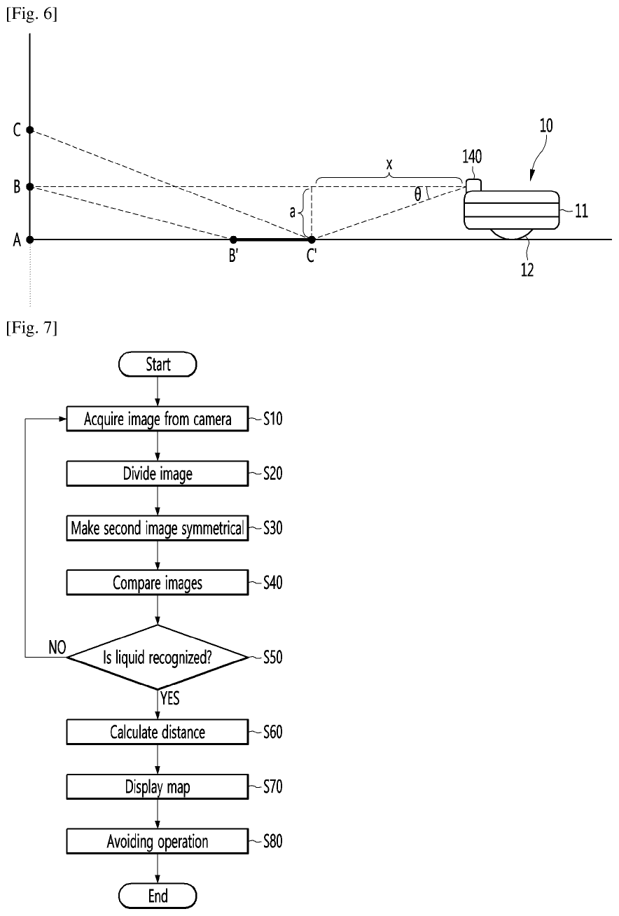

FIG. 3 is a block diagram showing the configuration of the controller according to an embodiment of the present disclosure, FIG. 4 is a view showing a state in which an image is divided with respect to a reference line, according to an embodiment of the present disclosure, FIG. 5 is a view showing a state in which the presence or absence of a liquid is determined by using a divided image, according to an embodiment of the present disclosure, and FIG. 6 is a view showing a state in which the robot cleaner calculates a distance to the liquid, according to the present embodiment.

According to the drawings, the controller 170 may include an image division part 171 that divides an image captured by the camera 140 into a plurality of images with respect to a reference line A. The captured image 20 may be divided into a plurality of images with respect to the reference line A. For example, the captured image 20 may be divided into a first image 21 and a second image 22 with respect to the reference line A.

The controller 170 may further include an image symmetry part 172 that calculates a third image 23 in which the second image 22 is symmetrical with respect to the reference line A.

In addition, the controller 170 may further include an image comparison and analysis part 173 that compares and analyzes the first image 21 and the third image 23.

The controller 170 may further include a distance calculation part 174 that calculates the distance to the liquid.

In the present specification, the controller 170 has been described as including the image division part 171, the image symmetry part 172, the image comparison and analysis part 173, and the distance calculation part 174, but one configuration may perform all the functions, or one configuration may perform two or more functions.

The image division part 171 may set the reference line A in the image 20 acquired by the camera 140.

For example, the image division part 171 may recognize a boundary line between a wall and a floor surface in the acquired image 20 and set the boundary line as the reference line A.

The image division part 171 may divide the image 20 into a plurality of images with respect to the set reference line A. For example, the plurality of images may include the first image 21 and the second image 22.

For example, referring to FIG. 4, the reference line A may be a boundary line between a wall surface and a floor surface. The boundary line may be a straight line or a curve.

The first image 21 may be an image on the upper side with respect to the reference line A, and the second image 22 may be an image on the lower side with respect to the reference line A.

While the robot cleaner 10 is moving, the camera 140 may periodically capture the surroundings to acquire an image. The images acquired by the camera 140 may be divided into the first image 21 and the second image 22 by the image division part 171 and continuously stored in the memory 160.

The image symmetry part 172 may generate the third image 23 in which the second image 22 is symmetrical with respect to the reference line A. The generated third image 23 may be stored in the memory 160.

For example, when the reference line A is a horizontal line, the image symmetry part 172 may make the second image 22 symmetrical with respect to the horizontal line. That is, the second image 22 and the third image 23 may be vertically inverted images.

The image comparison and analysis part 173 may extract a plurality of feature points by image-processing the first image 21 and the third image 23. Since the method for extracting the feature points may vary according to an image processing technique, a detailed description of the image processing technique will be omitted.

In an embodiment, the image comparison and analysis part 173 may determine the presence or absence of the liquid by comparing positions of first feature points B, C, D, E, F, and G extracted from the first image 21 with positions of second feature points B′, C′, D′, E′, F′, and G′ extracted from the third image 23.

More specifically, referring to FIGS. 2 and 4, when the liquid is present on the floor surface, it can be seen that the image of the wall surface is inverted with respect to the reference line A and projected.

Therefore, the image of the wall surface appears on the first image 21. In addition, an image of the floor surface in which the liquid on which the image of the wall surface is projected is present may appear on the second image 22.

Therefore, part of the first image 21 appears in a portion of the third image 23 which is calculated from the second image 22 and in which the liquid is present.

That is, in the portion of the third image 23 in which the liquid is present, the second feature points B′, C′, D′, E′, F′, and G′ corresponding to the first feature points B, C, D, E, F, and G may be extracted.

When the second feature point B′, C′, D′, E′, F′, and G′ corresponding to the first feature point B, C, D, E, F, and G are extracted from the third image 23, the controller 170 may determine that the liquid is present around the robot cleaner 10.

In addition, the image comparison and analysis part 173 may detect a feature point C′ located closest to the cleaner body 11 among the second feature points B′, C′, D′, E′, F′, and G′ through image analysis.

In the above, the embodiment in which the image comparison and analysis part 173 compares and analyzes the first image 21 and the third image 23 has been described, but the present disclosure is not limited thereto. An embodiment in which the first image 21 and the second image 23 are directly compared and analyzed is also possible.

As an embodiment, the image division part 171 may divide the image 20 into the first image 21 and the second image 22 with respect to the set reference line A, and the image comparison and analysis part 173 may extract a plurality of feature points by image-processing the first image 21 and the second image 22.

That is, the image comparison and analysis part 173 may determine the presence or absence of the liquid by comparing positions of first feature points extracted from the first image 21 with positions of second feature points extracted from the second image 22. In more detail, the image comparison and analysis part 173 may determine the presence or absence of the liquid by directly comparing the first feature points with the second feature points. In addition, the image comparison and analysis part 173 may determine the presence or absence of the liquid by making the second feature points symmetrical with respect to the reference line A and then comparing the second feature points with the first feature points.

If the liquid is present, the distance to the liquid may be calculated through the distance calculation part 174.

In more detail, referring to FIG. 6, the distance calculation part 174 may detect the second feature point C′ located at a shortest distance r from the cleaner body 11 among the plurality of second feature points B′, C′, D′, E′, F′, and G′. In addition, an angle θ from the camera 140 to the second feature point C′ located at the shortest distance r from the cleaner body 11 may be calculated. In addition, a height a from the floor surface to the camera 140 is stored in the memory 160. Therefore, the shortest distance (r) value at which the cleaner body 11 is separated from the liquid may be calculated by using the formula r=a*cot θ.

Hereinafter, a liquid detection method when the robot cleaner 10 is traveling will be described.

FIG. 7 is a flowchart of a method for controlling the robot cleaner, according to an embodiment of the present disclosure.

In the robot cleaner 10 according to the embodiment of the present disclosure, image information is acquired by the camera 140 while the robot cleaner 10 is traveling (S10).

The controller 170 of the robot cleaner 10 sets the reference line A from the acquired image and divides the acquired image into the first image 21 and the second image 22 with respect to the set reference line (A) (S20).

The first image 21 may be an image on the upper side with respect to the reference line A, and the second image 22 may be an image on the lower side with respect to the reference line A. The reference line A may be a boundary line at which the wall surface and the floor surface are in contact with each other, the first image 21 may be an image of the wall surface, and the second image 22 may be an image of the floor surface.

For example, when the liquid is present on the floor surface, the image of the wall surface may be inverted and projected on the liquid. Therefore, part of the first image 21 projected by the liquid may be inverted up and down in the second image 22.

The first image 21 and the second image 22 may be stored in the memory 160.

The controller 170 may extract the third image 23 in which the second image 22 is symmetrical with respect to the reference line A (S30).

For example, when the reference line A is a horizontal line, the second image 22 is made symmetrical with respect to the horizontal line. That is, the second image 22 and the third image 23 are vertically inverted images.

Therefore, when part of the first image 21 projected by the liquid is inverted up and down in the second image 22, part of the first image 21 projected by the liquid appears in the third image 23.

After extracting the third image 23, the controller 170 compares and analyzes the first image 21 and the third image 23 (S40).

In more detail, a plurality of feature points are extracted by image-processing the first image 21 and the third image 23. When the liquid is present, a plurality of first feature points B, C, D, E, F, and G may be extracted from the first image 21, and a plurality of second feature points B′, C′, D′, E′, F′, and G′ corresponding to the plurality of first feature points B, C, D, E, F, and G may e extracted from the third image.

The robot cleaner 10 may determine the presence or absence of the liquid based on the plurality of first feature points B, C, D, E, F, and G and the plurality of second feature points B′, C′, D′, E′, F′, and G′ (S350).

In more detail, when the second feature point B′, C′, D′, E′, F′, and G′ corresponding to the first feature point B, C, D, E, F, and G are extracted from the third image 23, the controller 170 may determine that the liquid is present.

When the second feature point B′, C′, D′, E′, F′, and G′ corresponding to the first feature point B, C, D, E, F, and G are not extracted from the third image 23 and thus the controller 170 determines that the liquid is not present, the controller 170 may continue traveling.

Meanwhile, when it is determined in operation S50 that the liquid is present, the shortest distance from the liquid may be calculated based on the second feature point C′ located at the shortest distance from the robot cleaner 10 among the plurality of second feature points B′, C′, D′, E′, F′, and G′ (S60). In the present embodiment, the second feature point C′ located at the shortest distance from the robot cleaner 10 among the plurality of second feature points B′, C′, D′, E′, F′, and G′ may be referred to as a reference feature point (S60).

Alternatively, the reference feature point that is the shortest distance from the robot cleaner 10 is further extracted from part of the first image 21 projected by the liquid in the third image 23, and the distance between the extracted reference feature point and the robot cleaner 10 may be calculated.

In an embodiment, the robot cleaner 10 may acquire an angle θ from the camera 140 to the second feature point C′ located at the shortest distance r from the cleaner body 11.

In an embodiment, since a distance a from the floor surface to the camera is stored in the robot cleaner 10, the robot cleaner 10 may calculate the shortest distance r through the formula: r=a(cot θ).

The robot cleaner 10 may display an area where the liquid is present on a map based on the calculated distance (S70).

In an embodiment, the robot cleaner 10 may continuously calculate a plurality of shortest distance r to the liquid while traveling, may calculate an area where the liquid is present based on the plurality of shortest distances r, and may display the area on the map.

In an embodiment, the robot cleaner 10 further includes an output interface that provides notification to the user and displays the liquid on the map, the robot cleaner 10 may notify the user of the recognition of the liquid through the output interface.

In addition, the robot cleaner 10 may operate while avoiding the liquid area displayed on the map (S80).

Therefore, since the cleaner body 11 does not pass through the liquid, it is possible to prevent the floor surface from being contaminated by the robot cleaner 10 or to prevent the liquid from being suctioned by the suction part of the robot cleaner 10 to cause malfunction.

According to the embodiment of the present disclosure, since the presence or absence of a liquid may be determined based on the information about the image captured by the camera provided in the robot cleaner, the robot cleaner may move while avoiding the liquid.

Therefore, since the robot cleaner does not pass through the liquid, it is possible to prevent the bottom surface of the robot cleaner from being contaminated by the robot cleaner or to prevent the liquid from being suctioned by the suction part of the robot cleaner.

According to the embodiment of the present disclosure, since the presence or absence of liquid may be determined based on the information about the image captured by the camera provided in the robot cleaner, the robot cleaner may move while avoiding the liquid.

Therefore, since the robot cleaner does not pass through the liquid, it is possible to prevent the floor surface from being contaminated by the robot cleaner or to prevent the liquid from being suctioned by the suction part of the robot cleaner. Therefore, the present disclosure is industrially available.

It will be understood that the above-described embodiments are illustrative and nonlimiting in all respects, and the scope of the present disclosure will be indicated by the following claims rather than the above detailed description. The meaning and scope of the claims to be described below will be construed such that all changeable and deformable forms derived from the equivalent concept fall within the scope of the present disclosure.

1. A robot cleaner comprising:
a cleaner body comprising a traveling part;
a camera provided on one surface of the cleaner body and configured to acquire an image of surroundings of the cleaner body; and
a controller provided in the cleaner body and configured to control the traveling part,
wherein the controller is configured to:
divide an image acquired by the camera into a plurality of images with respect to a reference line; and
determine the presence or absence of a liquid based on two or more images among the plurality of divided images.

2. The robot cleaner according to claim 1, wherein the reference line is a boundary line between a wall surface and a floor surface in the image acquired by the camera.

3. The robot cleaner according to claim 1, wherein the plurality of images comprise a first image and a second image, and
wherein the two or more images are the first image and the second image.

4. The robot cleaner according to claim 3, wherein the controller is configured to
acquire a third image in which the second image is symmetrical with respect to the reference line, and
determine the presence or absence of the liquid by using the first image and the third image.

5. The robot cleaner according to claim 4, wherein the controller is configured to
extract a plurality of first feature points extracted from the first image and a plurality of second feature points extracted from the third image, and
determine the presence or absence of the liquid based on matching information about the plurality of second feature points corresponding to the plurality of first feature points.

6. The robot cleaner according to claim 3, wherein the controller is configured to
extract a plurality of first feature points extracted from the first image and a plurality of second feature points extracted from the second image, and
determine the presence or absence of the liquid based on matching information about the plurality of second feature points corresponding to the plurality of first feature points.

7. The robot cleaner according to claim 6, wherein the controller is configured to
make the plurality of second feature points symmetrical with respect to the reference line, and
determine the presence or absence of the liquid by using matching information about the plurality of second symmetrical feature points and the plurality of first feature points.

8. The robot cleaner according to claim 5, wherein, when the controller determines that the liquid is present, the controller is configured to acquire a reference feature point located at a shortest distance from the cleaner body in the third image, and
calculate the shortest distance based on the reference feature point.

9. The robot cleaner according to claim 8, wherein the reference feature point is one of the plurality of second feature points.

10. The robot cleaner according to claim 8, wherein the controller is configured to acquire the reference feature point separately from the plurality of second feature points.

11. The robot cleaner according to claim 8, wherein the controller is configured to
detect an angle from the camera to the reference feature point located at the shortest distance from the cleaner body, and
calculate the shortest distance based on a height from the floor surface to the camera.

12. The robot cleaner according to claim 8, wherein the controller is configured to
generate a map based on the information acquired from the camera, and display, on the map, an area where the liquid is present, based on the shortest distance.

13. The robot cleaner according to claim 12, wherein the controller is configured to cause the cleaner body to travel while avoiding the area where the liquid is present.

14. A method for controlling a robot cleaner, the method comprising:
acquiring an image by capturing an image of surroundings through a camera while traveling;
dividing the acquired image into a plurality of images based on a reference line;
determining the presence or absence of a liquid based on two or more images among the plurality of images; and
when it is determined that the liquid is present, displaying, on a map, an area where the liquid is present, and driving the robot cleaner to avoid the area where the liquid is present.

15. The method according to claim 14, wherein the reference line is a boundary line between a wall surface and a floor surface in the image acquired by the camera.

16. The method according to claim 14, wherein the plurality of images comprise a first image and a second image, and
wherein the two or more images are the first image and the second image.

17. The method according to claim 16, wherein the determining of the presence or absence of the liquid comprises extracting a plurality of first feature points extracted from the first image and a plurality of second feature points extracted from the second image, and determining the presence or absence of the liquid based on matching information about the plurality of second feature points corresponding to the plurality of first feature points.

18. A method for controlling a robot cleaner, the method comprising:
acquiring an image by capturing an image of surroundings through a camera while traveling;
dividing the acquired image into a first image and a second image based on a reference line;
acquiring a third image in which the second image is symmetrical with respect to the reference line;
determining the presence or absence of a liquid based on the first image and the third image; and
when it is determined that the liquid is present, displaying, on a map, an area where the liquid is present, and driving the robot cleaner to avoid the area where the liquid is present.

19. The method according to claim 18, wherein the determining of the presence or absence of the liquid comprises extracting a plurality of first feature points extracted from the first image and a plurality of second feature points extracted from the third image, and determining the presence or absence of the liquid based on matching information about the plurality of second feature points corresponding to the plurality of first feature points.

20. The method according to claim 18, wherein the reference line is a boundary line between a wall surface and a floor surface in the image acquired by the camera.
